(19) United States
(12) Patent Application Publication
(10) Pub. No.: US 2006/0281188 A1
(43) Pub. Date: Dec. 14, 2006

(54) Ratiometric test strip and method

(75) Inventors: Samuel J. Mann, New York, NY (US); Linda M. Gerber, Brooklyn, NY (US)

Correspondence Address: Peter G. Carroll;MEDLEN & CARROLL, LLP, Suite 350, 101 Howard Street, San Francisco, CA, 94105, US

(73) Assignee: Cornell Research Foundation, Inc.

(21) Appl. No.: 11/451,285

(22) Filed: Jun. 12, 2006

Related U.S. Application Data
(60) Provisional application No. 60/689,863, filed on Jun. 13, 2005.

(51) Int. Cl. G01N 31/22

(52) U.S. Cl. 436/169

(57) ABSTRACT

The invention generally relates to devices, systems and methods adapted for use by patients for monitoring their own dietary intake of sodium without any need of laboratory facilities or collection of blood samples. The systems utilize test strips for measuring the concentration of analytes in urine, specifically, chloride and creatinine. Urinary chloride concentrations, normalized by creatinine concentrations to reduce variability contributed mainly by changing states of hydration serve as a conveniently monitored surrogate for salt intake by subjects, especially patients with hypertension or congestive heart failure who must control their salt intake carefully.

### FIELD OF THE INVENTION

The invention generally relates to systems, devices and methods, adapted for use by patients and medical personnel without laboratory facilities, for the simultaneous measurement of the concentration of chloride and creatinine in urine, and a method of using the measurements as a surrogate measure of cumulative sodium excretion, without the need for collecting a blood sample. The excretion of sodium, so measured, is useful as an indirect means of monitoring salt intake (dietary or otherwise) in subjects, especially those suffering from conditions such as hypertension or heart failure.

### BACKGROUND OF THE INVENTION

Despite the widely acknowledged impact of salt intake on patients' blood pressure and on their responsiveness to antihypertensive medication, salt intake is rarely monitored in clinical practice, either directly by measuring the amount of salt ingested or administered over time, or indirectly by measuring the mass of salt excreted in a given interval of time. Conventional means for doing either one are simply too inaccurate and inconvenient. A means that would permit salt intake to be assessed as often as the patient or the doctor desires could substantially improve the care and self-care of millions of patients with hypertension. A similar benefit would accrue in the management of patients with congestive heart failure, in whom salt intake is of even more critical importance.

Salt intake is an important factor in the control, or lack of control, of hypertension and of congestive heart failure. Sixty million Americans have hypertension, and blood pressure is adequately controlled in only half of this cohort. In most hypertensives, blood pressure increases with increased salt intake, and falls with reduced intake. This is true for both treated and untreated patients, and the relationship holds in both controlled and uncontrolled hypertension. Salt intake also affects responsiveness to most classes of antihypertensive medication. For patients with borderline hypertension, medication is less likely to remain optional as salt intake increases. Patients with established hypertension require more medication than they would otherwise need. Physicians therefore routinely advise patients to reduce their salt intake as a means to reduce medication and better control their blood pressure, but neither they nor their doctors have a reliable, practicable way of knowing whether changes they have made in their diet have in fact reduced their salt intake.

Salt intake is even more of an issue in the management of patients with heart failure (a population exceeding 5 million Americans) than it is in hypertensives. Excessive salt intake is often a major barrier to management of congestive heart failure, and a cause of hospitalizations for heart failure and mortality, yet often goes undetected because salt intake is not monitored.

Ready and reliable knowledge of a patient's salt intake would enable medical practitioners to know if salt intake is unacceptably high over time, and in those cases to re-emphasize dietary changes. It would also help in selecting antihypertensive drugs: the doctor could prescribe a higher than usual diuretic dose to patients with a high salt intake, particularly if their blood pressure is resistant to the usual dosage. In contrast, for a patient whose tests reveal low salt intake, the doctor would be forewarned not to go to a higher dose of the diuretic, and instead to add or increase other medications. These steps would help in controlling resistant hypertension, and would help avoid the adverse metabolic effects associated with the use of a diuretic dose that is excessive for a given individual. In persons with “high normal” blood pressure, now called “prehypertension,” doctors could suggest a trial of salt restriction and monitor both the reduction in salt intake and the impact on the patient's blood pressure, thus potentially preventing or forestalling the need for antihypertensive medication.

For their part, many patients seek to avoid or minimize medication. The most important non-pharmacologic interventions involve dietary change, and restriction of salt intake is clearly one of the most important. A convenient means of monitoring salt intake would provide to such patients the feedback they need to enable them to determine the impact of what they are eating, and to identify and eliminate the worst offenders. Patients would be able to monitor their salt intake on a regular basis and provide feedback to their doctor, which would assist in their treatment.

The need for salt restriction is not the same for all patients. For a patient with severe heart failure, salt restriction can make the difference between doing well versus repeated hospitalizations and death. For them, the importance of sodium restriction, and of a means to measure how they are doing, can be literally lifesaving. For patients with hypertension, it can mean the difference between less medication and more medication, and between controlled hypertension versus uncontrolled hypertension.

The level of sodium intake that is desirable varies with the diagnosis (heart failure vs. hypertension) and the severity of the condition (mild vs. severe, controlled vs. uncontrolled). As a rule of thumb, for hypertension the desired goal of salt restriction is sodium excretion of <80 mEq a day, or roughly 2 grams (2000 mg) of sodium per day. For patients with heart failure, more severe restriction, to as low as 30 or 40 mEq a day (roughly 1 gram of sodium per day) may be needed.

There is no specific number that defines high salt intake. An intake above 150 mEq per day, roughly 3500 mg of sodium, is the American average, and an intake higher than this would be considered high. A value that falls in between 2000 and 3500 mg per day (between 80 and 150 mEq) would be considered intermediate. A method of monitoring that would provide a specific number for salt intake or even a general categorization of low, intermediate or high intake would greatly improve matters.

Several factors in the current state of the art discourage such monitoring, however. Obtaining diet history is not a realistic option both because it is time-consuming and because patients' reports of their salt intake are notoriously inaccurate. At present, the most widely available alternative, and the current “gold standard” for monitoring salt intake, is the 24-hour urine collection to measure sodium excretion. However, this method is not optimal. It is far too inconvenient for regularly repeated monitoring. Inconveniences include carrying a bottle all day, remembering to collect urine each time, and making a trip to bring each urine collection to the doctor or laboratory. Also, 24-hour urine collections are not as accurate as might be thought, both because many patients fail to collect all urine, and because collection is limited to the salt intake on a single day, which often is not representative of average salt intake over a longer period of time. An alternative method, overnight urine collection, is virtually never done in clinical practice because salt excretion estimated from overnight collections often differs substantially from salt excretion estimated from 24-hour collections, and because specimens still must be transported to the laboratory.

The widespread use of home glucose monitoring and home blood pressure monitoring in recent years has revolutionized the management of diabetes and hypertension. Home monitoring enables patients to track their progress as closely as necessary, at little expense. Self-monitoring also involves patients in their own care, and improves their compliance with prescribed medication. Glucose and blood pressure measurements are routinely employed in self-care because modern technology has made them relatively inexpensive, simple to perform, accurate, convenient and non-aversive. Similarly improved systems and methods for monitoring salt intake are needed to provide ready information to doctors in adjusting dosages of diuretics and in treating patients with hypertension and heart failure, particularly when these conditions are not responding to the medications being used. Patients themselves need such systems and methods in order to become more involved in their own care and to better monitor their diets, all at minimal expense and inconvenience.

### BRIEF SUMMARY OF THE INVENTION

The invention specifically relates to the treatment of patients for whom excessive salt intake, usually dietary intake, poses a health risk. Patients with hypertension or heart failure are exemplary. The invention provides systems, kits and methods of using the systems' devices to enable patients to monitor their own salt intake indirectly by measuring, simultaneously, the concentrations of creatinine and of electrolytes, especially chloride, in the urine, expressing the measurements as ratios, and drawing inferences therefrom, all without need of laboratory facilities or collection of blood samples. Physicians can also make the measurement without a laboratory.

In one embodiment, the present invention contemplates a test strip loaded with reagents capable of reacting with a substance in a body fluid of a subject, preferably a substance produced endogenously by the subject, which substance enters the lumens of renal tubules exclusively, or at least chiefly, via filtration through the renal glomeruli and is not then significantly reabsorbed into the bloodstream. Creatinine is exemplary. For convenience, such strip may be referred to hereinafter as a “filtration strip.” The filtration strip measures the urinary concentration of analytes such as creatinine to provide an index of the rate at which water is filtered from the bloodstream.

In one embodiment, a test strip is loaded with reagents capable of reacting chemically, electrochemically or otherwise with a substance in a body fluid of a subject, which substance is ingested by the subject or administered to the subject parenterally. Dietary electrolytes are exemplary, including sodium, potassium and, especially, chloride. Other electrolytes, including hydrogen ions and bicarbonate, that may or may not arise directly from the diet but may be beneficially monitored to better realize the invention, are also contemplated. For convenience, such strip may be referred to hereinafter as a “monitor strip” because it measures the urinary concentration of the analyte being monitored, whereas the filtration strip merely provides a means of normalizing values that the monitor strip acquires.

Read-outs for the filtration strip and the monitor strip may independently be electrometric or may be spectrometric across the entire electromagnetic spectrum, but colorimetric read-outs that rely on the naked eye are most preferred.

In one embodiment, to control for background noise in the readings, test strips are provided that are not reagent-loaded.

In one embodiment, to calibrate read-outs, standard solutions of analytes at concentrations within physiological range for most subjects are provided.

In one embodiment, a filtration strip and a monitor strip are combined for simultaneous use. The mode of combining does not limit the invention. In one embodiment, the strips are used separately. In this case, the strips may be used in seriatim to make their use practicable, as long as the passage of time doesn't substantially affect the comparability of the readings. In one embodiment, the strips are used simultaneously but are physically separated from one another in space. In one embodiment, the reagents are integrated with one another, essentially as a mixture, on a single retentive supporting matrix. Only the respective reaction products are distinguished when the strip is read. In one embodiment, the concentration of one of the analytes affects the reaction (e.g., the rate of the reaction or the net accumulation of product) of the other analyte in such a way that the required ratiometric information can be deduced by following only one reaction. In a preferred embodiment, the respective reagents occupy separate “channels” on a single retentive supporting matrix but remain unmixed. The channels may be isolated from one another by any means, including but not limited to a hydrophobic barrier, the use of matrix materials with anisotropic capillarity, etc. In one embodiment, the respective reagents reside in an array of separate spots on a retentive matrix.

It is to be understood that additional strips, spots, reactant sets (reagents and analytes), etc. may be incorporated in various ways into the embodiments described above without changing the scope of the invention. Thus, for example, control strips, reference standard strips, and strips to monitor two or more analytes at once may be added. In one embodiment, an analyte may undergo one or more dilutions in a diluent that resides in the matrix in such a way that the strip can report read-outs at one or more analyte dilutions.

In one embodiment, the present invention provides a method of monitoring dietary intake of a substance comprising providing (i) a subject desiring to monitor his or her intake of the substance, (ii) a filtration strip, and (iii) a monitor strip; immersing at least a portion of the filtration strip and the monitor strip in a sample of the urine of the subject, and reading the changes (accumulation of reaction products or disappearance of reactants) induced in the filtration strip and in the monitor strip. The readings are expressed as a ratio adjusted by an appropriate published value for the amount of filtration strip analyte excreted per day. The result is converted to an expression of salt intake. The calculations may be done arithmetically or by looking up the ratio in an appropriate table or nomogram. It is preferred that each strip have a dynamic range such that the method in which they are used permits at least semi-quantitative estimates of intake between 20 mg/kg body weight/day and 100 mg/kg/day, more preferably between 10 and 500 mg/kg/day, and most preferably between 0 mg/kg body weight/day and 1500 mg/kg/day.

In a preferred embodiment of the invention, a test strip means of measuring the concentration of at least two substances in the same sample of urine is provided.

In a most preferred embodiment, the substance of interest to be monitored is chloride. Alternative substances of interest are sodium, potassium, bicarbonate, hydrogen ion (pH) and divalent cations such as calcium.

### Definitions

An “analyte” is a substance whose presence or amount in a mixture, suspension or solution is sought to be determined by an analytical method. Analytes of particular interest in the instant case are the chloride ion and the creatinine molecule, each dissolved in an aqueous solution, namely urine.

The term “anisotropic capillarity” refers to a material having capillarity in one direction but not in an orthogonal direction. A drop of water placed on a sheet of such material would not spread out in a circular pattern but would form a relatively narrow line on the sheet.

“Blood pressure” is the pressure exerted by the blood on the walls of a blood vessel through which the blood passes. In this case, the term refers more specifically to systemic arterial blood pressure.

“Bloodstream” refers to the compartment in the body that holds the body's circulating blood and lymph.

“Body fluid” refers to any liquid found in the body, either within cells (“intracellular fluid”) or outside cells (“extracellular fluid”), especially any body fluid whose amounts and composition are susceptible to regulation by physiological processes.

“Colorimetric” refers to any means of measurement or analysis wherein the qualitative or quantitative appreciation of color, or a change in color, whether discerned or appreciated visually or with the aid of instrumentation, is a factor in such measurement or analysis. The broader term “spectrometric” includes calorimetric determinations but extends to electromagnetic energies outside the visual spectrum that only instrumentation can detect.

“Concentration” refers to the amount of a substance admixed with a given amount of another substance. Especially, in this case, the term refers to an amount of a substance dissolved in another substance, whether said amount is measured as dry mass or as a “chemical activity” as used in the law of mass action.

As used herein, “controlled” refers to a disease condition (e.g., high blood pressure) that is asymptomatic in conventional tests because a medical or other intervention is successfully controlling the symptoms. The same disease is “uncontrolled” if no intervention has been made. Typically, but not always, any uncontrolled disease for which a diagnostic test exists is symptomatic by such test.

The term “cumulative excretion” or simply “excretion” refers to the total mass of a substance excreted in the urine in a given amount of time. Accuracy of the measure depends on complete collection of all urine excreted (typically in a “24-hour collection”), accurate measurement of the collected volume, and accurate measurement of the concentration of the substance in the collected urine.

The term “dehydrated” generally refers to a condition characterized by a lower than normal amount of water in the body. Herein, the term may also be used to refer to a “hypovolemic” condition. Strictly speaking, hypovolemia is a condition in which the volume of blood in the bloodstream, specifically, is less than normal—without regard to the volume of other fluid compartments in the body.

The “diet” refers generally to the beverages and foodstuffs a subject voluntarily ingests by mouth. Herein, however, “intake” and “diet” may be used interchangeably even though “intake” could extend to parenteral (by-passing the gut) or rectal administration, stomach tube, etc. “Dietary salt intake” refers generally to sodium chloride, but may refer also to other salts.

“Diet histories” are typically created from patients keeping diaries of what they ate and when. By making certain assumptions about the make-up of the ingested foodstuffs, the patient's intake of a particular substance over a particular period can be reconstructed.

A “dipstick,” also referred to herein as a “titration stick,” “titrator stick,” “strip” or “test strip,” comprises a “matrix,” viz., any material capable of (1) being configured as a dipstick or test strip, (2) retaining by adsorption, absorption, sequestration or otherwise one or more elements that undergo a state-change in the presence of an analyte of interest, and (3) permitting an analyte to interact with said element(s) to yield said state-change. Measurement of the state-change amounts to a “read-out” of the activity of the analyte. It is preferred in this case that the elements that undergo state-change be chemical reagents retained in or on the matrix at least until such reagent(s) react in response to an analyte contacting said reagent(s) to yield a readable reaction product. Although preferred, the reaction product need not be retained on the test strip for the read-out. Although preferred, the reaction product need not be on the test strip when read out but in solution or on an “indicator strip,” which indicator strip may be a separate strip or a separate part of a compound strip. A “readable” reaction product is a product susceptible to detection, preferably at a specific concentration or level of chemical activity within a range, by any means, including but not limited to colorimetric, electrometric, and spectrometric.

The device used herein to detect levels or concentrations of creatinine in urine samples on read-out is referred to as the “filtration strip,” and the device used to detect levels or concentrations of urinary chloride on read-out is called the “monitor strip.” Monitor strips are calibrated by using them to measure “standards” (pre-determined concentrations of chloride ion dissolved in a liquid having solutes approximating in kind and quantity urinary solutes). For filtration strips the standards contain pre-determined concentrations of creatinine.

A “diuretic” is any agent that increases the production of urine (“diuresis”). The term typically refers to a drug, but many other factors and agents are diuretic in that they can cause diuresis. These also fall within the definition of “diuretic” herein.

A “double dipstick” as used herein is a dipstick that combines at least one of the reagents needed for the analysis of each of at least two distinct chemical species in a device designed to be handled as if it were a dipstick that tests for a single species. One variation of a double dipstick combines a function for measuring an analyte that is present and a function for measuring the background when such analyte is not present.

“Dry chemistry” or “solid-state chemistry” does not necessarily imply that water or other solvents are absent, but refers to analytical chemical tests wherein at least one step of the reaction that enables the test does not take place in a space where the diffusion path for reactants in solution is substantially the same in all directions.

“Electrolytes” are substance that dissociate into free ions when molten or when dissolved to produce an electrically conductive medium. Informally, and in the instant case, any one of the ionic species that comprise an electrolyte may also be referred to as an electrolyte.

“Electrometric” is a measurement based upon electrical potential or a change in electrical potential. An electrometric measurement may be read as electrical current, resistance or potential or transductions thereof.

The term “endogenous” refers to anything found in an organism, or emanating from an organism, that arose within the organism.

“Excessive salt intake” is any amount of salt (especially sodium chloride in this case) ingested or administered in a given period in excess of salt lost in perspiration, defecation, etc., and minimal excretion (about 2.5 to 4 grams per day in man). For the purposes of the instant invention, the terms “salt intake, “sodium intake,” “salt excretion,” or “sodium excretion” may each be used interchangeably with “chloride-to-creatinine ratio,” and with one another, with the understanding that the ratio is a dimensionless number requiring a conversion factor to become an expression of intake or excretion of salt or sodium. Ordinary arithmetic, software, a look-up table, a nomogram or any other means of making the conversion are within the scope of the invention.

Generally herein, the term “excretion” refers to urinary excretion of a substance, but where the context so admits, the term refers to the escape of a substance (typically, “wastes”) from the body, whether in urine, feces, perspiration, tears, saliva, mucus, sebum, or otherwise.

Generally herein, the term “filtration” refers to glomerular filtration, but also encompasses any process wherein particles (which may be ions, atoms, molecules, crystals, polymers, aggregates, organisms, etc.) dissolved or suspended in a medium are separated from the medium by retention within a barrier that does not retain the medium.

“Glomerular filtrate” is the product of a filtration process in which a specialized endothelium (the “renal glomerulus”) located at the head of each of thousands of “renal tubules” in the kidney serves as a barrier to blood cells, proteins and other formed elements of the blood but does not retain the water, ions and small molecules that comprise the filtrate.

“Heart failure” refers to a usually chronic condition in which the heart cannot pump an adequate amount of blood to the body's other organs. Herein, the term refers especially to heart failure that compromises the kidney's ability to excrete sodium and water. This form of failure is often called “congestive heart failure” but herein the terms may be used interchangeably.

A “hydrophobic barrier” separates regions that contain water by interposing a structure whose surface tends to repel water.

The symptom of high blood pressure, if chronic, defines “hypertension” as the term is used herein. The term, which is synonymous with “arterial hypertension,” refers to an underlying condition of not necessarily known etiology.

“Inert matrix” as used herein means a matrix that does not substantially affect the read-out of a chemical reaction that takes place in, or in association with, the matrix.

An “intake index” is an empirically acquired relation, expressible as a “look-up” table, for example, derived from repeated, managed studies that acquire actual cumulative excretion of the substance of interest over time along with the concentrations of the substances on the filtration and monitor strips, expressed as a ratio.

A “laboratory” comprises instrumentation that enables at least the performance of the chemical analyses referred to herein but requires trained personnel for its operation and maintenance.

In reference to the dipsticks or test strips of the instant invention, the term “loaded” refers to a test strip that has in place on the strip at least one reagent for the analytical reaction that will take place on the strip. An “unloaded” strip is the same except that it lacks the reagent(s).

“Inulin” is an oligosaccharide that freely passes through the glomerular endothelium but does not enter the lumens of renal tubules by any secretory process and is not reabsorbed from the tubules back into the blood. The ratio of its concentration in urine to its concentration in blood times the volume flow of urine therefore closely approximates the glomerular filtration rate.

“Normalized” refers to data mathematically adjusted by a factor such that the elements of the factored dataset are more readily compared than the elements of the unfactored dataset. “Ratiometric” normalization obtains when two independent variables depend in common on a third variable; the ratio of the two independent variables tends to yield data devoid of variations attributable to the third variable.

A “patient” herein refers to a human or an animal, especially domestic and husbanded animals. The terms “patient” and “subject” are used interchangeably.

A chemical reaction is “read” by measuring the disappearance (specifically, the rate or degree of disappearance) of a reactant in the reaction or the appearance (the rate or degree of appearance) of a reaction product of the reaction. The measurement may be calibrated by means of a “reference standard,” which is a pre-determined amount or concentration of a reactant or reaction product.

A “reagent” is a chemical substance, which becomes a reactant in a chemical reaction that results in a reaction product.

A “semi-quantitative” measure merely distinguishes the measurement over “detection,” a purely qualitative measure of “present-or-absent.”

A “surrogate” herein refers to an activity or amount of a chemical detected or measured to provide an estimate of another chemical activity or amount that is not actually measured.

As used herein, “urine” refers to an aqueous solution that forms in the kidney as glomerular filtrate or “presumptive urine” and passes through the lumen (inner bore) of thousands of tubules (“renal tubules”) where much of the water returns to the bloodstream (i.e., the kidney “recaptures” or “reabsorbs” the water) while solutes (dissolved ions and molecules) are both added (by “secretion”) and removed by reabsorption. The “final urine” enters the bladder and ultimately leaves the body during urination. A “urine sample” is a sample of final urine of sufficient volume to permit effective use of the filtration stick and the monitor stick.

Terms such as “urine chloride” or “urinary creatinine” refer generally to the chemical concentration of the particular substance in a sample of urine. For purposes of the instant invention, however, such terms may refer, where the context so admits, to the total mass of the substance in a volume of urine.

### BRIEF DESCRIPTION OF THE FIGURES

The description of the invention, particularly the Examples will be better understood when read in conjunction with the appended figures. The figures merely present in graphic form what is described and do not limit the invention in any way.

FIG. 1 shows the relationship between urinary chloride measured by dipstick and by a specialized instrument in a laboratory.

FIG. 2 shows the relationship between urinary chloride measured by dipstick and urinary sodium measured by a specialized instrument in a laboratory.

FIG. 3 shows the relationship between urinary chloride and urinary sodium, both measured by a specialized instrument in a laboratory.

FIG. 4 shows the relationship between urinary creatinine measured by dipstick and by a specialized instrument in a laboratory.

FIG. 5 shows the relationship between the urinary choride/creatinine ratio measured by dipsticks and by a specialized instrument in a laboratory.

FIG. 6 shows the relationship between the urinary chloride/creatinine ratio measured by dipsticks and the urinary sodium/creatinine ratio measured by specialized instruments in a clinical laboratory.

FIG. 7 shows one embodiment of a test strip device. FIG. 7A is a cross-sectional view, and FIG. 7B is a top view.

### DETAILED DESCRIPTION OF THE PREFERRED EMBODIMENTS

Applicants believe, without binding themselves to any theory of why the claimed invention works, that the kidney subserves three distinct functions with respect to certain substances circulating in the blood. The kidney (1) filters from the blood, at a generally invariant rate, an essentially protein-free and cell-free solution of water and solutes, the filtered solution being referred to as the glomerular filtrate; (2) adds certain blood-borne solutes to the glomerular filtrate by secretory processes, and (3) reabsorbs certain solutes, and a large proportion of the water, from the glomerular filtrate back into bloodstream.

It is understood, further, that the body's extracellular and intracellular fluids must maintain a balance of mineral salts, principally sodium chloride and potassium chloride. The diet is the usual source of these salts, as is the water in which the salts are dissolved. The kidney's filtration, secretion and reabsorption functions, in concert with thirst, appetite, and satiety, maintain the balance. Modern man and domestic animals require only minimal sodium intake, but tend to ingest more than necessary. Fortunately the kidney, although naturally “tuned” to recapture sodium (and water) from the glomerular filtrate, is generally able to relinquish all excess ingested sodium into the final urine over time.

A relatively low urinary concentration of any solute that reaches a given volume of urine solely as a result of filtration, especially if the body produces that solute at a constant rate, can only mean that the kidney is relinquishing relatively large amounts of water to the final urine. The term “relative” acquires its meaning in this context by making comparisons with other urine samples collected from a subject in a series or by comparing the results to a table of normal values. In any event, if the urinary concentration of sodium is proportionately low in the same “watery” sample, sodium intake is probably relatively constant. If the sodium concentration is disproportionately low, sodium intake is probably decreasing. If the sodium concentration is not low or is relatively elevated, sodium intake is probably increasing.

A relatively high urinary concentration of any solute that reaches a given volume of urine solely as a result of filtration, especially if the body produces that solute at a constant rate, means that the kidney is conserving water to deal with a relatively dehydrated condition. In such case, the urinary concentration of sodium would need to be disproportionately high to unambiguously indicate increased sodium excretion (the kidney sometimes conserves or recaptures water not to dilute excess solutes in the blood, but to restore normal volume to the circulatory system).

A number of substances reach the urine principally by filtration. Creatinine is the one most well known that doesn't need to be injected into the subject. The body's muscles generate creatinine constitutively, at a remarkably constant rate. A number of chemistries have been derived to measure creatinine concentrations quantitatively in urine, blood plasma and other body fluids. An exemplary chemistry, which can be used in a test strip format, was developed by Pugia, et al. That chemistry is described and claimed in U.S. Pat. No. 5,374,561. Cast and Pugia were awarded U.S. Pat. No. 6,001,656 on an improvement of the method. Both patents are incorporated herein in their entirety by reference, in part to provide guidance in making and using a filtration strip. The U.S. Pat. No. 6,001,656 patent describes an assay for creatinine in urine in which the urine is contacted with a reagent system comprising cupric ions, a hydroperoxide and an oxidizable dye together with 4-hydroxy-2-methylquinoline. The 4-hydroxy-2-methylquinoline may be present in the reagent system at a concentration of from 10 to 300 mM, the hydroperoxide can be diisopropyl benzene dihydroperoxide and the oxidizable dye can be 3,3′,5,5′-tetramethylbenzidine. Other methods for determining creatinine activity that may find use in the instant invention are described in the following U.S. patents, incorporated herein: U.S. Pat. Nos. 5,610,073, 5,702,955, 5,733,787, 6,210,971, and 6,872,573.

The other substance of interest in the preferred embodiment is chloride. U.S. Pat. No. 5,229,299 describes and claims a solid-state test device for determining chloride (and other halides) in aqueous samples. The patent is incorporated herein in its entirety by reference, to provide guidance in making and using a monitor strip. U.S. Pat. No. 5,229,299 describes a device for testing fluids containing alkaline hydroxyl ions for the presence and amount of halide ions using a porous matrix incorporating an effective amount of a silver dichromate reagent which gives a measurable calorimetric response in the presence of halide ions, the improvement comprising including in the matrix an effective amount of a cationic substance that substantially prevents the formation of silver hydroxide and other oxide products, where the substance has no calorimetric response in the presence of halide ions that would interfere with the measurement of the colorimetric change in the silver dichromate reagent system. The cationic substance is selected from the group consisting of non-halogen water-soluble salts of zinc, aluminum, magnesium, lead, bismuth, iron+2 and molybdenum.

In one embodiment, the invention provides a means of acquiring all relevant analytes from the sample simultaneously, and reacting them simultaneously, not only for convenience but to maximize accuracy in this ratiometric analysis. An example of a device that achieves this objective is described in U.S. Pat. No. 5,710,372, incorporated herein in its entirety by reference. The solid-state device comprises a plurality of spaced apart test regions on an inert support, each test region comprising an inert matrix impregnated with a reagent selectively interactive with the analyte of interest. Another example is provided by U.S. Pat. No. 6,413,473, also incorporated herein in its entirety by reference. The teachings of these patents are included to provide guidance for making a combined filtration strip and monitor strip.

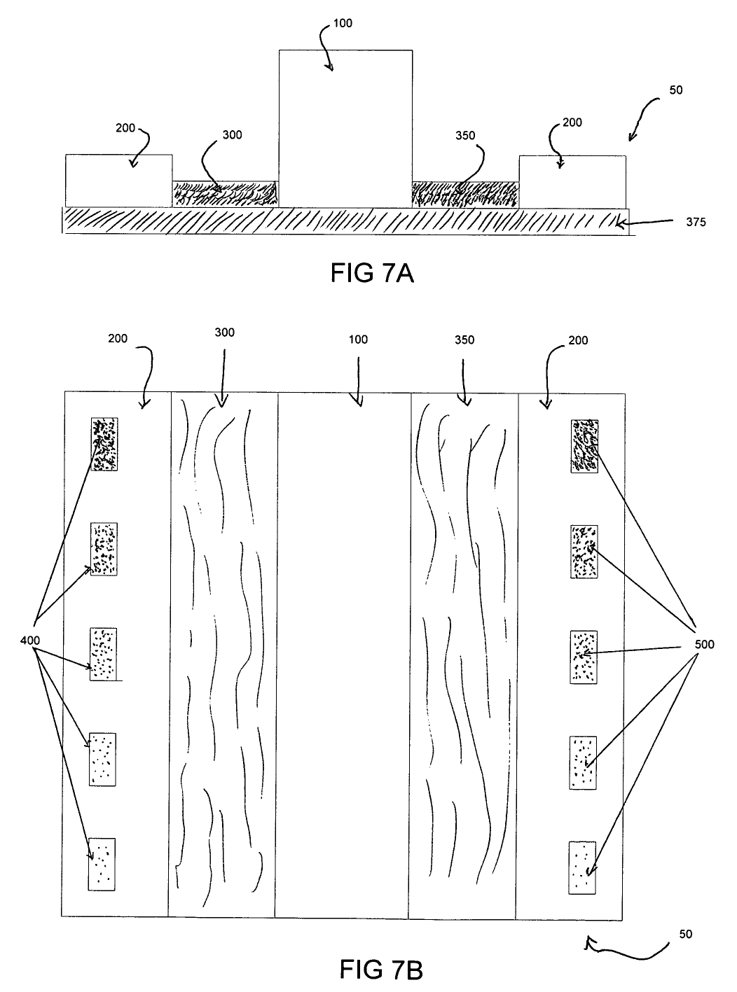

One embodiment of a solid-state device that finds use in the instant invention is depicted in FIG. 7 by way of example only and not of limitation. The device 50 appears in cross-section in FIG. 7A. FIG. 7B presents a top-down view. A hydrophobic barrier 100 separates reagent strips 300 and 350. Barrier 100 and reagent strips 300 and 350 are supported by substrate 375. The reagent strips are made from a bibulous material. Reagent strip 300 is loaded with reagents required for the detection of creatinine (the “filtration strip”). Reagent strip 350 is loaded with reagents required for the detection of chloride ion (the “monitor strip”). Panel 200 carries color reference chips 400 to aid the read-out of filtration strip 300. Panel 250 carries color reference chips 500 for reading out monitor strip 350. The device or “dipstick” 50 is dipped into a sample of urine and removed when each strip is saturated. After a pre-determined development time, the color of each reaction is estimated with the help of the graded color chips 400 and 500.

To realize the object of enabling patients to determine their salt intake as often as desired, and at low cost, by means of a simple urine test, the inventors have adopted two recent advances in analytical chemistry. The first is a chloride titrator stick. Although measuring urinary sodium instead of chloride would improve the precision of the instant invention, the primary object of the invention is simplicity. At this time, measuring sodium concentration in liquids is not amenable to practice outside an analytical laboratory such as a clinical laboratory, and there certainly is no such thing as a sodium dipstick. It is well known that urinary chloride concentration tends to fairly closely parallel urine sodium concentration in stable patients. However, it is not predictable that urinary chloride is equivalent to urinary sodium for the purposes of the instant invention. Without subscribing to or relying upon any particular mechanistic explanation, the inventors believe that such divergence can occur because the absorption of each of these ions from the glomerular filtrate and their secretion into glomerular filtrate as the filtrate passes through the lumens of the renal tubules are independently regulated. In this connection, it is not entirely certain whether it is the sodium or the chloride component of salt that actually drives blood pressure (Boegehold M A, Kotchen T A. Importance of dietary chloride for salt sensitivity of blood pressure. Hypertension 1991; 17:Suppl I: I158-I161). Morgan TO. The effect of potassium and bicarbonate ions on the rise in blood pressure caused by sodium chloride. Clin Sci 1982/63:407s-409s.)

The use of a titrator stick to measure urinary chloride concentration would eliminate the need to transport the urine specimen to a laboratory for chloride testing, and would enable one to sample the urine for its chloride concentration as often as desired. However, chloride concentration imparts no information about the mass of chloride excreted over time, absent an additional measurement such as a timed and measured collection of urine. The concentration of most substances found in urine can vary considerably depending on the subject's hydration status, so measuring concentration alone in a spot sample reflects neither total daily sodium nor chloride excretion adequately.

A second advance in analytical chemistry, the urine creatinine titrator stick, has the potential to solve this problem. Within any individual, total 24-hour creatinine excretion assessed from repeated 24-hour urine collections indicates clearly that 24-hour excretion of creatinine is quite constant. On the other hand, in stable patients, the concentration of creatinine varies considerably, depending almost entirely on the individual's state of hydration. With modest dehydration and reduced urine output, concentration is higher, and vice versa. This is why measurement of concentration alone does not adequately reflect the 24-hour creatinine excrewtion. However, since creatinine excretion is a constant, the concentration of creatinine reliably reflects the urine volume, and serves as a surrogate for volume measurement. Therefore, assessing the ratio of urinary sodium concentration to urine creatinine concentration in spot urine samples effectively measures sodium excretion. A convenient means of measuring urine chloride concentration, combined with a convenient measure of urine creatinine concentration in could therefore replace the inconvenient assay for sodium and the unrealistic need to measure urine volume in repeated 24-hour urine collections. Instead, one would sample salt excretion as often as desired and not be limited to information about salt balance in a single 24-hour period.

The notion of using the concentration of creatinine in a particular sample of urine as a “normalizing” factor to allow one to compute the excreted mass of an analyte, given knowledge of the concentration of that analyte in that sample of urine, is familiar in the art. U.S. Pat. No. 5,559,036 to Mienie, et al., offers the method to assess total excreted mass of (organic) metabolites. Gauntley et al. (U.S. Pat. No. 4,159,193) use the approach for a specific metabolite, aminolevulinic acid. Provonost et al., (U.S. Pat. No. 5,804,452) recommend its use in their “dry chemistry” technology as a normalizing factor in evaluating the excretion of pancreatic amylase, steroid hormones and metabolites thereof, and proteins whose excretion marks bone resorption or deposition. Bransgrove et al. (WO 96/04554) use it with a test strip to determine excreted mass of calcium. Pugia, et al., Eur. J. Clin. Chem. Clin. Biochem. 335:693, 1997) uses a “double-dipstick” for creatinine and albumin to measure albumin excretion. These authors showed that the dipstick technique compares favorably with the traditional Jaffe wet chemistry method for assaying urinary creatinine.

Kell (WO 99/02983) teaches measurement of urinary creatinine concentration along with the specific gravity of the urine sample to detect adulteration of a sample provided by a donor for drug screening. In this case, creatinine is not used to normalize another analyte. Instead, the converse applies: the specific gravity measurement is used to normalize the measured creatinine value so that it can be compared to a database of normal creatinine values.

Flack et al. (Flack J M, Grimm R H Jr., Staffileno B A, Dnsc, Elmer P, Yunis C, Hedquist L, Dudley A. “New salt-sensitivity metrics: variability-adjusted blood pressure change and the urinary sodium-to-creatinine ratio.” Ethn Dis. 2002; 12:10-9), in an attempt to correlate sodium excretion and blood pressure, relied on sodium/creatinine ratios as did Khaw, et al. (Khaw, K-T, Bingham, S., Welch, A., Luben, R., O'Brien, E., Wareham, N., and Day, N. “Blood pressure and urinary sodium in men and women: the Norfolk cohort of the European Prospective Investigation into Cancer (EPIC-Norfolk) Am. J. Clin. Nutr. 2004; 80:1397-1403) in an epidemiological study. These authors refer to others who have also used the ratio in population studies. Although these reports on investigations with sodium/creatinine ratios lend some plausibility to the instant invention, they do not describe an equivalent invention: In measuring sodium itself, all these investigators, perforce, used laboratory-based equipment. A feature of the instant invention is that its embodiments are free of the laboratory.

Chloride determinations by dry chemistry are taught in the art. U.S. Pat. No. 4,211,532 discloses a test strip especially adapted to determine chloride ion in cow's milk. U.S. Pat. No. 4,444,193 provides a skin patch for use in the management of patients with cystic fibrosis (“CF”). The patch detects chloride above a pre-determined level in sweat (see also a similar but improved CF patch in U.S. Pat. No. 6,042,543). U.S. Pat. No. 4,650,768 describes a device comprising a porous matrix impregnated with silver salts and carrageenan. The device is said to be suitable for detecting chloride in urine. No suggestion is made, however, to use the device to measure chloride excretion, in cooperation with creatinine or otherwise. U.S. Pat. No. 4,744,952 describes a “test paper” for determining the concentration of halogen ions (including chloride) in urine and other fluids. Again no concept having to do with combining the test with either a creatinine measurement or the more reliable inulin measurement can be found. U.S. Pat. No. 5,229,299 describes a chloride test strip with a colorimetric readout that is not obscured by secondary products of the reaction (e.g., silver oxide). Its contemplated application is chloride detection in cement.

In summary, in clinical practice today, although monitoring of salt intake would be of great clinical importance in the management of hypertension and of heart failure, it is simply not done. The present invention solves this problem through the use of systems or devices in methods that semi-quantitatively monitor chloride/creatinine ratios from spot urines in a simple procedure and that provide a reliable and convenient way to provide data for hypertensive or heart failure patients and their doctors to use as often as desired in assessing salt intake so as to make effective dietary adjustments.

### EXAMPLES

The examples below will further illustrate how the test strips may be used in the invention. They are not to be construed as limiting the scope thereof.

### Example 1

To document that
(1) measurement of urinary chloride concentration by the chloride titrator stick adequately approximates measurement by standard laboratory technique;
(2) measurement of urinary chloride concentration by both laboratory and titrator stick adequately approximates measurement of urinary sodium concentration;
(3) measurement of urinary creatinine concentration by dipstick adequately approximates measurement by standard laboratory technique;
(4) measurement of chloride/creatinine ratio by titrator sticks approximates measurement of this ratio by standard laboratory technique;
(5) measurement of chloride/creatinine ratio by titrator stick adequately approximates measurement of sodium/creatinine ratio by standard laboratory technique;
(6) categorizing subjects as having low, medium or high urinary chloride concentration based on measurement by titrator stick is consistent with categorization based on measurement of urinary chloride by standard laboratory technique, and
(7) categorization of subjects as having low, medium or high urinary chloride/creatinine ratio based on measurement by titrator stick is consistent with categorization based on measurement of chloride/creatinine ratio and sodium/creatinine ratio by standard laboratory technique, we performed the following study.

With Institutional Review Board approval, we obtained spot urine specimens from 31 subjects including hypertensive and normotensive individuals in stable health. We included subjects with normal and with reduced but stable renal function. Subjects were recruited at the Hypertension Center of the Weill Medical College of Cornell University. Two aliquots were prepared from the urine. One was kept for measurement of chloride and creatinine using titrator sticks, and the other was sent to the New York Presbyterian Hospital Clinical Laboratory for standard laboratory measurement of chloride, sodium and creatinine. All specimens were tested on the day the specimens were received.

Titrator stick measurements were performed using Quantab Chloride Titrator™ strips (Hach Co, Loveland, Colo.), and a Microalbustix™ strip containing a pad for creatinine (Bayer Diagnostics, Elkhart, Ind.). Other currently available test strips for urinary creatinine are Multistix PRO Urinalysis Strips™ that uses a pad for creatinine or a Clinitek 50™ urine chemistry analyzer (Bayer Diagnostics, Elkhart, Ind.).

When a Hach Quantab™ test strip is completely saturated, a moisture sensitive string across the top of the titrator turns brown. The 0-10 scale on the strip can be divided into easily read increments of 0.2. Hach Test Strips are semi-quantitative and are accurate to ±10 percent (Hach Company, Loveland, Colo.).

Chloride strips were placed into test tubes containing a spot urine sample and allowed to react until the indicator thread turned brown, indicating completion of the reaction. The height of the column on the numbered Quantab™ scale was read, and, using the conversion table, was converted into chloride concentration.

Creatinine sticks were dipped into the urine and then quickly removed, excess urine was shaken off the strip, and then the stick was read at 60 seconds by comparing the color at 60 seconds with the color spectrum representing various creatinine concentrations. The concentration that most closely matched the color on the strip was then recorded.

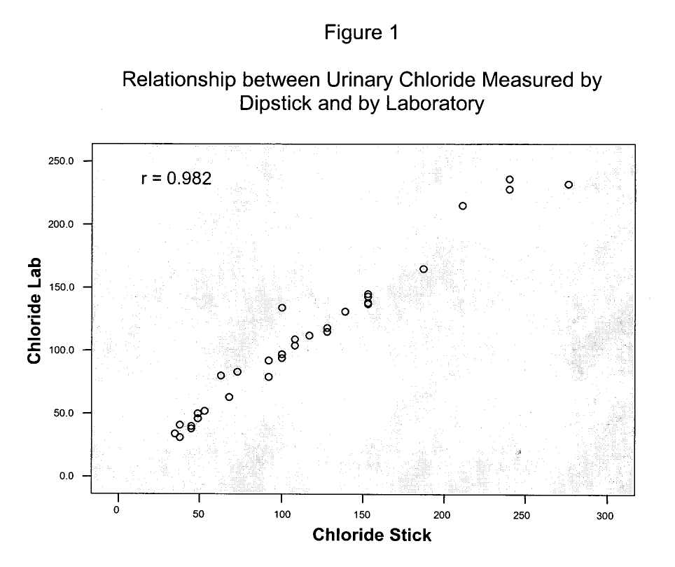

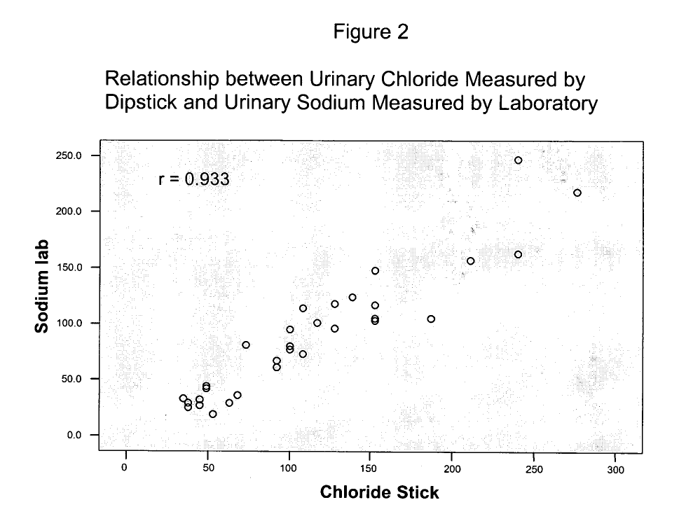

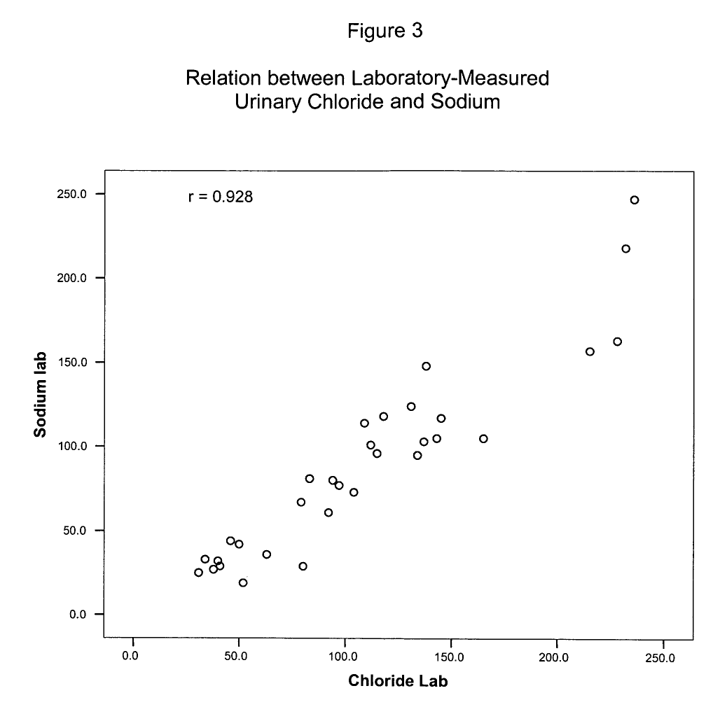

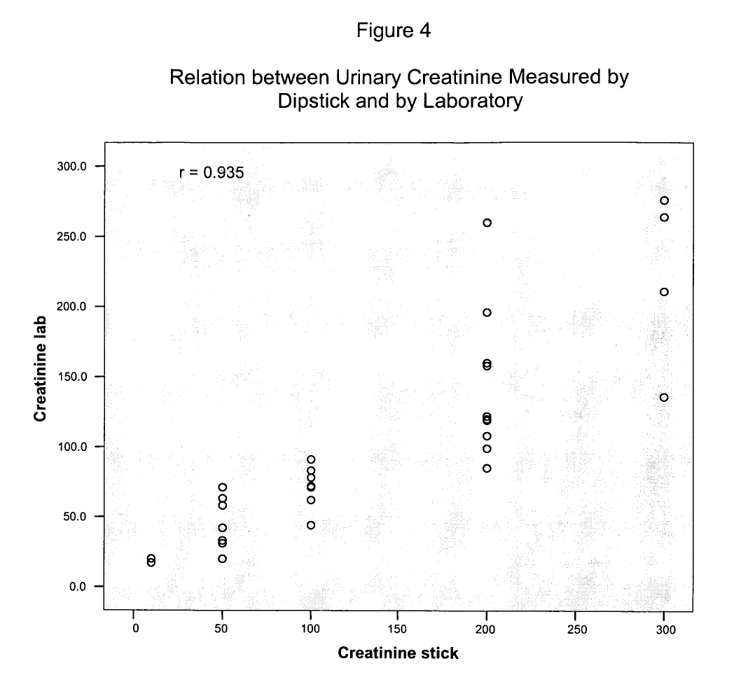

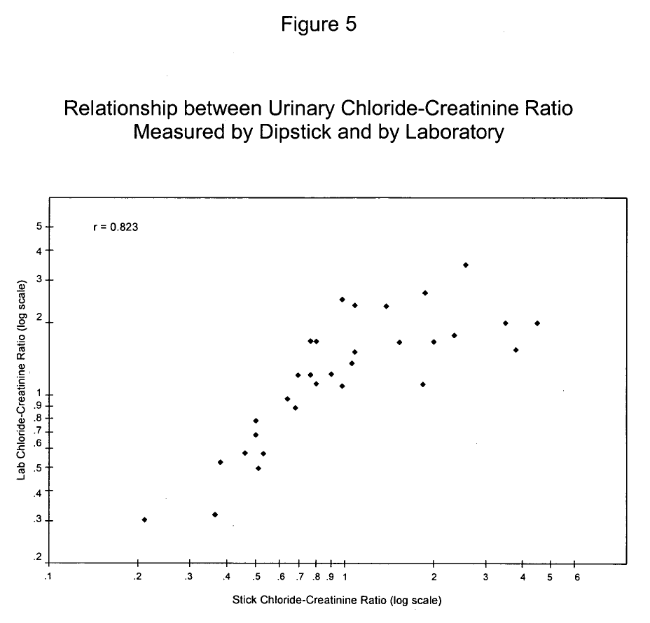

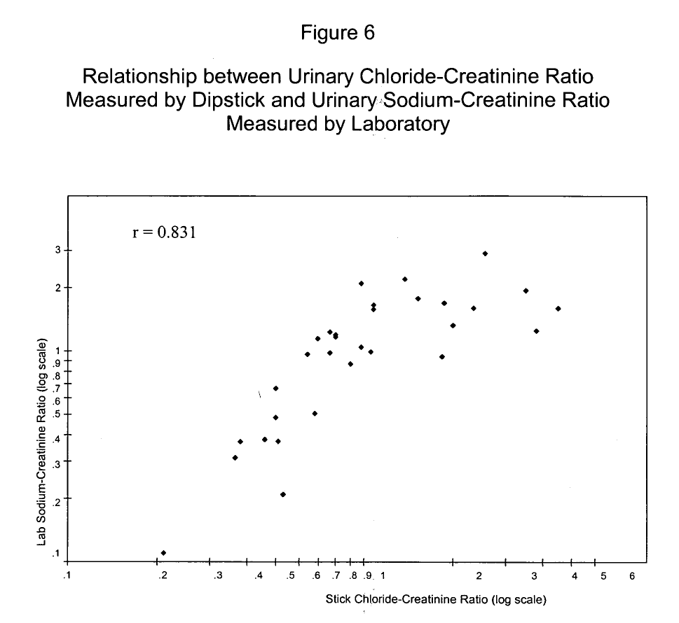

The relationship of dipstick measurement of chloride and creatinine concentrations to laboratory measurement of chloride, creatinine, and sodium were calculated by Spearman's correlation coefficient. Similarly, the dipstick chloride to creatinine ratio was compared to the laboratory chloride to creatinine ratio, as well as to the laboratory sodium to creatinine ratio. Scatterplots showing the bivariate relationships are presented (dipstick chloride vs. laboratory chloride, FIG. 1; dipstick chloride vs. laboratory sodium, FIG. 2; laboratory chloride vs. laboratory sodium, FIG. 3; dipstick creatinine vs. laboratory creatinine, FIG. 4; dipstick ratio vs. laboratory ratio for chloride-creatine, FIG. 5; dipstick ratio for chloride-creatinine vs. laboratory ratio for sodium-creatinine, FIG. 6).

Laboratory and dipstick measurements of chloride concentration and of chloride/creatinine ratio were categorized into tertiles (low, middle, high) to determine the degree of agreement between assessments. The number of subjects who were categorized to the same tertile by both laboratory and titrator stick methods was assessed by the Kappa statistic. The number of subjects categorized to the same tertile by dipstick chloride-creatinine ratio versus laboratory sodium-creatinine ratio was similarly assessed. Finally, categorization into tertiles based on chloride concentration was compared to categorization based on chloride/creatinine ratio, to document whether categorization by these two variables produced similar or different results.

Two-tailed probability levels for statistical significance tests are reported. Analyses were performed in SPSS Version 13.0 (SPSS Inc., Chicago, Ill.).

Precision of Dip Stick Assay

Dipstick chloride concentration correlated very strongly with both laboratory chloride concentration (r=0.98) and laboratory sodium concentration (r=0.93) (p<0.0001 for each), as shown in FIGS. 1 and 2. Laboratory chloride and sodium concentrations also correlated very strongly with each other (FIG. 3; r=0.93, p<0.0001). We also found a strong correlation between dipstick creatinine concentration and laboratory creatinine concentration (FIG. 4; r=0.94, p<0.0001). The dipstick chloride/creatinine ratio also correlated strongly with both laboratory chloride/creatinine ratio (r=0.83) and laboratory sodium/creatinine ratio (r=0.82)(p<0.0001 for each), as shown in FIGS. 5 and 6.

Assessing Agreement Between Semi-Quantitative Categories

Agreement between dipstick and laboratory measures was very highly significant when results were categorized by tertiles. Table 1 shows that for urinary chloride concentration, there was a high concordance between the two methods (dipstick and laboratory), with agreement between the two methods in 87% (27/31) of subjects. In the four instances in which there was disagreement, the methods differed by one category. In no instances was chloride concentration low by one method and high by the other.

TABLE 1
Tertiles of Urinary Chloride Measured by Dipstick by Tertiles of Urinary
Chloride Measured by Laboratory

| | |
|---|---|
| | Tertiles of Urinary |
| Tertiles of Urinary | Chloride by Dipstick |

| Chloride by Laboratory | Low | Middle | High | Total |
|---|---|---|---|---|
| Low | 9 | 1 | 0 | 10 |
| Middle | 1 | 9 | 1 | 11 |
| High | 0 | 1 | 9 | 10 |
| Total | 10 | 11 | 10 | 31 |

Kappa = 0.8, p < 0.0001

Similarly, there was very highly significant agreement between methods in categorization into low, medium, and high tertiles of chloride-creatinine ratios (p<0.001, Table 2). Again, non-agreement was by only one category, with no subjects having a high ratio by one method and low ratio by the other. Table 3 shows the same strong relationship between the chloride-creatinine ratio measured by dipstick and the sodium-creatinine ratio measured by laboratory.

TABLE 2
Tertiles of Urinary Chloride-Creatinine Ratio Measured by Dipstick
by Tertiles of Urinary Chloride-Creatinine Ratio Measured by
Laboratory

| | |
|---|---|
| | Tertiles of Urinary |
| Tertiles of Urinary | Chloride-Creatinine |
| Chloride-Creatinine | Ratio by Dipstick |

| Ratio by Laboratory | Low | Middle | High | Total |
|---|---|---|---|---|
| Low | 10 | 0 | 0 | 10 |
| Middle | 0 | 7 | 3 | 10 |
| High | 0 | 4 | 7 | 11 |
| Total | 10 | 11 | 10 | 31 |

Kappa = 0.7, p < 0.0001

TABLE 3
Tertiles of Urinary Chloride-Creatinine Ratio Measured by Dipstick
by Tertiles of Urinary Sodium-Creatinine Ratio Measured by
Laboratory

| | |
|---|---|
| | Tertiles of Urinary |
| Tertiles of Urinary | Chloride-Creatinine |
| Sodium-Creatinine Ratio | Ratio by Dipstick |

| by Laboratory | Low | Middle | High | Total |
|---|---|---|---|---|
| Low | 9 | 1 | 0 | 10 |
| Middle | 1 | 7 | 2 | 10 |
| High | 0 | 3 | 8 | 11 |
| Total | 10 | 11 | 10 | 31 |

Kappa = 0.7, p < 0.0001

Finally, we found that although both chloride and chloride/creatinine ratio vary directly with chloride concentration, the dipstick-measured-chloride concentration bore little relationship to the dipstick chloride/creatinine ratio (Table 4), thus documenting that the chloride/creatinine ratio is not redundant with chloride concentration.

TABLE 4
Tertiles of Urinary Chloride-Creatinine Ratio Measured by Dipstick
by Tertiles of Urinary Chloride Measured by Dipstick

| | |
|---|---|
| | Tertiles of Urinary |
| | Chloride-Creatinine |
| Tertiles of Urinary | Ratio by Dipstick |

| Chloride by Dipstick | Low | Middle | High | Total |
|---|---|---|---|---|
| Low | 4 | 3 | 3 | 10 |
| Middle | 5 | 2 | 4 | 11 |
| High | 1 | 6 | 3 | 10 |
| Total | 10 | 11 | 10 | 31 |

Kappa = −0.07, p = 0.71

The results indicate that urinary chloride assessed by the dipstick method is remarkably consistent with laboratory chloride determination, and without question provides a valid and convenient alternative to laboratory measurement of urinary chloride. The results also indicate that urinary chloride closely approximates urinary sodium concentration, and therefore serves as a reliable surrogate for sodium measurement, for which there is no dipstick available.

We have also documented that the dipstick chloride/creatinine ratio adequately approximates the laboratory chloride/creatinine and sodium/creatinine ratios. This suggests that the dipstick chloride/creatinine ratio method that we are introducing provides an alternative to laboratory measurement of sodium/creatinine ratio.

In our study, it is clear that categorization of subjects by chloride/creatinine ratio differed from categorization by chloride concentration alone. This is to be expected since chloride concentration alone does not account for the effect of variation in urine volume whereas chloride/creatinine ratio does.

### Example 2

To determine whether or not titrator stick chloride/creatinine ratios adequately approximate sodium excretion, urine samples are collected as above from a cohort of patients (30 subjects) from each of whom a 24-hour collection of urine is also obtained. Aliquots of each 24-hour urine sample, along with the “spot” urine samples (to be collected when each patient's 24-hour collection is delivered), are subjected to the same measurements and analyses as in Example 1. Correlation between dipstick chloride/creatinine ratio in the spot urine sample and 24-hour sodium excretion determined from the sodium concentration in an aliquot of the 24-hour urine collection is evaluated. The results allow an assessment of the power of the inventive approach compared to the “gold standard” for measuring dietary salt intake.

### Example 3

To document the clinical relevance of home monitoring of salt excretion by chloride/creatine ratios measured by titrator sticks, three 24-hour urine collections are taken from 30 subjects, at least a week apart, along with chloride/creatinine ratios acquired by dipstick from three corresponding spot urines (separate spot urines, rather than aliquots of the 24-hour collection, to be obtained at the time the 24-hour urine collection is brought in). The average dipstick chloride-creatinine ratio from the three spot urines predicts the average sodium content in the three 24-hour collections. The results complete the validation of the method and comprise the initial population of a database to permit the user to read total sodium excretion from chloride/creatinine ratios.

### Example 4

The study performed in Example 3 is repeated on a larger population (N=300), and relationships between chloride/creatinine ratio and clinical parameters such as blood pressure control, number of medications needed, diuretic dosage needed and plasma renin levels are assessed in subgroups defined by age, sex, race, and disease state.

### Example 5

The efficacy of the method is tested in the field by having patients (N=60) use the test strip method at home. Each subject is supplied with a kit comprising a suitable number of test strips that react with chloride in urine such that the reaction reaches an end-point that the subject can read visually, wherein the reading is a measure of the concentration of chloride in urine. The kit further comprises a corresponding number of test strips that react with creatinine in urine such that the reaction reaches an end-point that the subject can read visually, wherein the reading is a measure of the concentration of creatinine in urine. The kit also contains suitable receptacles to collect urine, a log book for recording salt intake values, blood pressure and other relevant events, and tangibly expressed instructions for use of the kit by a subject who wishes to monitor his or her salt intake. In addition to the written instructions, each subject is instructed by a trainer. Each subject uses the kit to check and record his or her chloride/creatinine ratio at least once a week over a period of 2 months, while antihypertensive medications remain constant. The log book is used to record dipstick results. Trends in salt excretion and changes in blood pressure are analyzed to demonstrate the effectiveness of home monitoring in reducing salt intake.

The initial read-outs of the test are urinary chloride concentration and urinary creatinine concentration. A look-up table or nomogram is provided to enable subjects to convert their readings into a result readily understood by patients and doctors. That result, based on the chloride/creatinine ratio and published values for creatinine excretion by age, weight, race and sex, is a derived estimate of the 24-hour sodium excretion. A wealth of such published values exists (Bingham et al., Ann. Clin. Biochem. 25:610-619, 1988; Knuiman et al., Hum. Nutr. Clin. Nutr. 40: 343-348, 1986; Kunkel et al., J. Am. Coll. Nutr. 10:308-314, 1991; Sugita et al., Ann. Clin. Biochem. 29: 523-528, 1992) to provide the basis for constructing a conventional nomogram. By way of example and not limitation, a subject whose readings are 150 mEq/liter for chloride, and 100 mg/dL for creatinine, selects a nomogram or table that accords with that subject's sex, race, and weight, finds “150” under “Chloride” and “100” under “Creatinine,” and reads “milligrams of sodium excreted per day” and in “milliEquivalents of sodium excreted per day.” In this example, the chloride/creatinine ratio, interpreted by the nomogram, yields a result of 5000 mg per day of sodium. The instructed subject readily recognizes this as high, and examines his or her recent diet history to identify ingested foodstuffs to be eliminated from the diet. A report to the patient's physician in milliEquivalents of sodium elicits decisions about the patient's prescribed diuretic regimen and diet.

### Example 6

Urinary chloride and urinary creatinine data are transformed into estimated values for 24-hr urine sodium excretion as follows:
1. Find subject's urinary chloride concentration as determined from monitor strip.
2. Find subject's urinary creatinine concentration as determined from filtration strip.
3. Find an estimate of 24-hr urine volume by looking up 24-hr creatinine excretion from an established nomogram known in the art (nomogram displays values by race, gender, weight, and age) and dividing by subject's urinary creatinine concentration as determined from filtration strip:

$$24 \text{-} hr chloride excretion = \frac{( chloride concentration ) ( published 24 \text{-} hr creatinine excretion )}{( creatinine concentration )}$$
4. Assume equivalent number of sodium ions and chloride ions are excreted and convert mg/day chloride to mg/day sodium according to the following relation:
   35.45 grams of Chloride is equivalent to 23.5 grams of sodium

Clinical example:

50 year-old, 160 lb African-American male:

estimated creatinine excretion (as published for subject's age, weight, race and sex)=2000 mg/day
monitor strip readout: Chloride=4000 mg/liter
Filtration strip readout: Creatinine=1000 mg/liter
   Computation:
1. chloride concentration: 4000 mg/liter
2. estimated 24-hr urine volume:
   (2000 mg creatinine per day)/(1000 mg creatinine per liter)=2 liters
3. 24-hr chloride excretion:
   (4000 mg/liter)(2 liters)=8000 mg chloride
4. Conversion to milliEquivalents:
   8000 mg chloride/35.45 mg/mEq=224 mEg chloride
5. Conversion to mg sodium (using sodium-chloride equivalency assumption):
   224 mEq sodium×23.5 mg/mEq=5264 mg sodium

What is claimed is:

1. A system for monitoring salt intake by a subject without laboratory facilities comprising:
(i) a monitor strip;
(ii) a filtration strip; and
(iii) a sample of said subject's urine.

2. The system of claim 1 further comprising a nomogram for converting a read-out of said monitor strip and a read-out of said filtration strip to a value for salt intake by said patient.

3. The system of claim 1 wherein said read-outs are spectrometric.

4. The system of claim 2 wherein said spectrometric read-outs are colorimetric.

5. The system of claim 3 wherein said calorimetric readouts are visually appreciable.

6. The system of claim 1 further comprising a monitor strip that is not reagent-loaded and a filtration strip that is not reagent-loaded.

7. The system of claim 1 further comprising a chloride standard and a creatinine standard.

8. A method of monitoring salt intake performed without laboratory facilities, comprising:
a) providing a first test strip capable of detecting chloride in urine, a second test strip capable of detecting creatinine in urine, and said patient's urine;
b) introducing said first and second test strips to said urine so as to obtain first and second values; and
c) calculating a ratio of said first and second values and finding a salt intake value therefrom.

9. The method of claim 7, wherein said urine is from a patient suspected to have high blood pressure.

10. The method of claim 7, wherein said patient carries out step (b) at home.

11. The method of claim 8, wherein said salt intake value is between more than about 0 mg/kg body weight/day and less than about 1500 mg/kg body weight/day.

12. The method of claim 8, wherein reduction in salt intake is indicated when said salt intake value exceeds more than about 50 mg/kg body weight/day.

13. The method of claim 7, wherein said second test strip comprises a quinoline.

14. The method of claim 7, wherein said first test strip comprises a silver dichromate reagent which gives a measurable calorimetric response in the presence of halide ions.

15. A method of monitoring salt intake without laboratory facilities, comprising:
a) providing a device comprising a first test region capable of detecting chloride in urine, a second test region capable of detecting creatinine in urine, said first and second regions on a single test strip, and said patient's urine;
b) introducing said first and second regions to said urine so as to obtain first and second values; and
c) calculating a ratio of said first and second values and finding a salt intake value therefrom.

16. A device comprising a first test region capable of detecting chloride in urine, a second test region capable of detecting creatinine in urine.

17. The device of claim 16, wherein said first and second regions are on a single test strip.

18. The device of claim 16, wherein said first and second regions are separated by a hydrophobic barrier.

19. The device of claim 16, wherein said first test region comprises a silver dichromate reagent which gives a measurable colorimetric response in the presence of halide ions.

20. The device of claim 16, wherein said second test region comprises a quinoline.

21. A kit comprising the testing device of claim 16 and instructions for operating the device.
